(19) United States
(12) Patent Application Publication
(10) Pub. No.: US 2025/0103958 A1
(43) Pub. Date: Mar. 27, 2025

(54) METHODS FOR GENEREATING A HONEYPOT

(71) Applicant: Robert Bosch GmbH, Stuttgart (DE)

(72) Inventors: Dominik Germek, Berlin (DE); Niclas Ilg, Ammerbuch (DE)

(21) Appl. No.: 18/884,541

(22) Filed: Sep. 13, 2024

(30) Foreign Application Priority Data
Sep. 21, 2023 (DE) 102023209243.3

(51) Int. Cl. G06N 20/00; H04L 9/40

(52) U.S. Cl. CPC G06N 20/00; H04L 63/1491

(57) ABSTRACT

A method for generating a honeypot for a target system. The method includes training a machine learning model to output, in response to an input (i.e., an input on which the machine learning model is trained) that includes a textual target system specification, a honeypot configuration matching the input (i.e., for a textually specified target system to be imitated by a honeypot, to output a suitable configuration for such a honeypot), receiving a textual specification of the target system, feeding the received textual specification to the trained machine learning model and generating a honeypot according to the configuration that the machine learning model outputs in response to the feed of the received textual specification.

### FIELD

The present invention relates to a method for generating a honeypot.

### BACKGROUND INFORMATION

The number of networked data processing devices (including embedded devices) is increasing rapidly. An important aspect of all these devices—be they server computers on the Internet or control devices in the automotive or IoT sector—is product security. Honeypots are decoys that imitate such a valuable (target) system in order to attract attackers and gain information about their attack strategies and targets. Honeypots are an established tool for threat analysis, especially in corporate IT, and they are now also used in the field of the (Industrial) Internet of Things ((I)IoT). Although honeypots are a very useful tool to complement the cybersecurity strategy, implementing honeypots for specific needs and the relevant target system requires a lot of manual work by experts.

Therefore, approaches that enable easier provision (in particular configuration) of a suitable honeypot for a given target system are desirable.

### SUMMARY

According to various embodiments of the present invention, a method for generating a honeypot for a target system is provided, comprising training a machine learning model to output, in response to an input (i.e., an input on which the machine learning model is trained) that includes a textual target system specification, a honeypot configuration matching the input (i.e., for a textually specified target system to be imitated by a honeypot, to output a suitable configuration for such a honeypot), receiving a textual specification of the target system, feeding the received textual specification to the trained machine learning model and generating a honeypot according to the configuration that the machine learning model outputs in response to the feed of the received textual specification.

The method of the present invention described above allows for a corresponding honeypot generating device to automatically create honeypot implementations for specific needs. The honeypot environment is derived from written system specifications, which can vary in nature: standardization documents (such as RFCs), internal (specific) specifications or vendor-specific specifications. These specifications are not statically cloned, but rather interpreted (by the machine learning model) in order to create a dynamic honeypot environment. This makes it possible to create a honeypot for completely different systems and protocols without cloning existing content, but rather using a description in order to derive a honeypot. Furthermore, the method described above allows for the automation of honeypot development and configuration for non-cybersecurity personnel, reducing the required expertise to configure honeypots (which is difficult to find), and it allows the overall security of a product or service to be increased, since honeypots can be configured automatically and thus at least a minimum level of honeypots can be configured with little effort.

According to various embodiments of the present invention, a complete honeypot implementation is automatically derived from system specifications. This not only automates work steps, but also enables in particular users who are not cybersecurity experts to build honeypot systems.

Various exemplary embodiments of the present invention are specified below.

Exemplary embodiment 1 is a method for generating a honeypot, as described above.

Exemplary embodiment 2 is the method according to exemplary embodiment 1, comprising removing data to be kept secret according to a confidentiality criterion from the textual specification prior to feeding the received textual specification to the trained machine learning model.

For example, sensitive data can be removed from a product description before it is fed into the machine learning model. This ensures that the output of the machine learning model is free of any sensitive data that might otherwise be reflected in the output. This can also be done for the input data of training examples in order to avoid sensitive data being reflected in the parameters (or ultimately also in the output) of the machine learning model (i.e., information about it can be obtained).

Exemplary embodiment 3 is the method according to exemplary embodiment 1 or 2, wherein the input on which the machine learning model is trained and the received textual specification in each case comprise a (textual) indication of services and/or protocols to be supported by the relevant honeypot and/or one or more operating systems to be supported.

These are typically important properties or functionalities of a target system that a honeypot is intended to imitate.

Exemplary embodiment 4 is the method according to one of exemplary embodiments 1 to 3, comprising evaluating the generated honeypot (e.g., for real attacks or automated test procedures (e.g., scans), it is evaluated whether the honeypot responds in the same way as the target system) and updating the machine learning model according to the evaluation.

Thus, the machine learning model can be gradually improved using one or more honeypots generated with it.

Exemplary embodiment 5 is the method according to one of exemplary embodiments 1 to 4, wherein the input on which the machine learning model is trained includes information in the form of a result of a static rule, and wherein the static rule is applied to the received textual specification (and, if applicable, additional information), and the received textual specification is fed to the machine learning model together with the result of the application.

In this way, static rules (i.e., predefined rules that do not change during the training of the machine learning model) for ascertaining the configuration can also be combined with the machine learning model. This can be, for example, a fixed rule as to which version of a honeypot software should be used (depending on the target system).

Alternatively, the output of the machine learning model can also be supplemented with the result of the application of such a static rule before a honeypot is generated accordingly.

Exemplary embodiment 6 is the method according to one of exemplary embodiments 1 to 5, wherein the input on which the machine learning model is trained includes at least one Boolean expression of target system functionalities and/or target system properties and wherein at least one Boolean expression is ascertained from the received textual specification (and, if applicable, additional information) and is fed to the machine learning model with the received textual specification.

The formation of Boolean expressions facilitates processing by the machine learning model.

Exemplary embodiment 7 is the method according to one of exemplary embodiments 1 to 6, wherein the machine learning model is a large language model.

This allows for effective processing of textual data, in this case the specification of the target system.

Exemplary embodiment 8 is a data processing system with a honeypot generating device that is configured to carry out the method according to one of exemplary embodiments 1 to 7.

Exemplary embodiment 9 is the computer program comprising commands which, when executed by a processor, cause the processor to carry out a method according to one of exemplary embodiments 1 to 7.

Exemplary embodiment 10 is a computer-readable medium storing commands which, when executed by a processor, cause the processor to carry out a method according to one of exemplary embodiments 1 to 7.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a computer network according to an example embodiment of the present invention.

FIG. 2 illustrates the configuration of a honeypot according to one example embodiment of the present invention.

FIG. 3 shows a flowchart illustrating a method for generating a honeypot for a target system according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples of the present invention are described in more detail below.

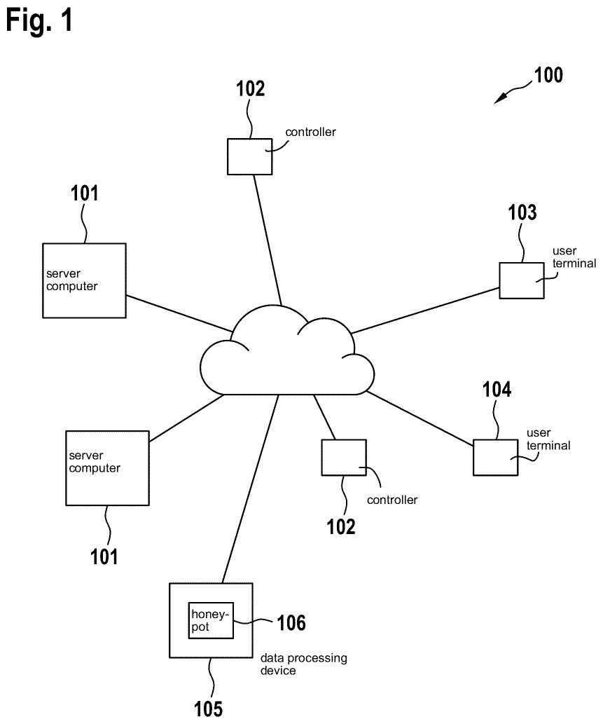

FIG. 1 shows a computer network 100. The computer network 100 includes a plurality of data processing devices 101-104, which are interconnected by communication links. The data processing devices 101-104 include, e.g., server computers 101 and controllers 102 along with user terminals 103, 104.

Server computers 101 provide various services, such as Internet sites, banking portals, etc. A controller 102 is, e.g., a control device for a robot device such as a control device in an autonomous vehicle. The server computers 101 and controllers 102 thus fulfill different tasks and typically a server computer 101 or a controller 102 can be accessed from a user terminal 103, 104. This is particularly the case if a server computer 101 offers a functionality to a user, such as a banking portal. However, a controller 102 can also allow access from outside (e.g., so that it can be configured). Depending on the task of a server computer 101 or controller 102, they can store security-related data and execute security-related tasks. Accordingly, they must be protected against attackers. For example, an attacker using one of the user terminals 104 could, through a successful attack, gain possession of secret data (such as keys), manipulate accounts or even manipulate a controller 102 in such a way that an accident occurs.

A security measure against such attacks is a so-called honeypot 106 (which is implemented by one of the data processing devices 105). It seemingly provides a functionality and thus serves as bait to attract potential attackers. However, it is isolated from secret information or critical functionality, so that attacks on it are effected in a controlled environment and the risk of compromising the actual functionality is minimized. In this way, it makes it possible to gain knowledge about attacks on a target system (e.g., one of the server computers 101 or one of the controllers 102) to which the implementation of suitable measures on the target system can respond, without these attacks endangering the target system.

However, providing a honeypot for a specific (target) system (such as a server computer 101 or a controller 102) in a way that makes it credible to potential attackers and actually provokes attacks is not easy and requires experience and/or detailed knowledge of honeypots and considerable effort.

According to various embodiments, an approach is therefore provided which allows for the automatic derivation of a honeypot from a technical, written system specification, without having any special knowledge about honeypots.

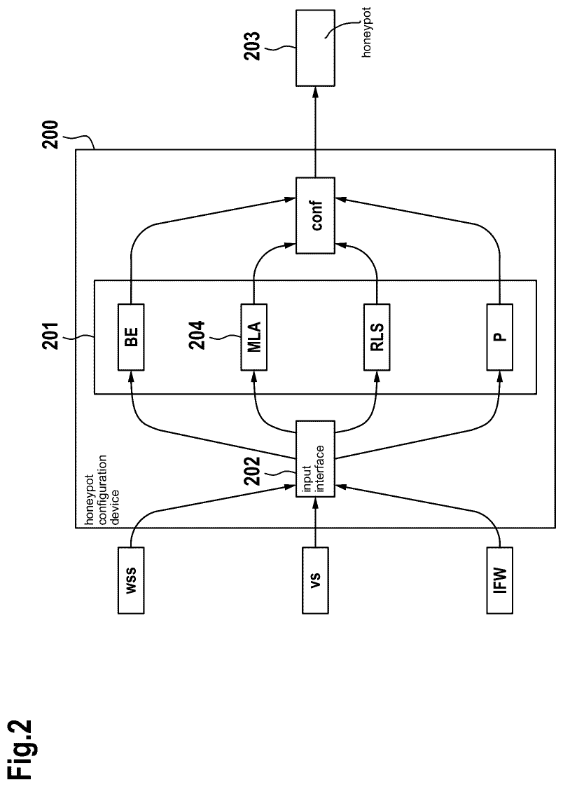

FIG. 2 illustrates the configuration of a honeypot according to one embodiment.

The configuration is effected by a honeypot configuration device 200, which corresponds, for example, to one of the user terminals 103, 104 (e.g., a computer with which a user (such as a system administrator) configures the honeypot 106 and instructs the data processing device 105 to provide the honeypot 106 thus configured).

Initially, a formal written system specification WSS, a vendor specification VS or an informal written description IFW is ascertained (e.g., received) or provided (e.g., via an input interface 202 of the honeypot configuration device 200) by a target system, e.g. an embedded controller 102.

The specification is then evaluated by an evaluation unit 201 of the honeypot configuration device 200. The evaluation is supported by a machine learning model 204, denoted by MLA in FIG. 2, (e.g., a large language model) and by one or more of a static set of rules RLS (e.g., for pattern recognition), Boolean expressions BE and/or any heuristic or deterministic procedure P for selecting suitable honeypots.

The result of the evaluation is a honeypot configuration for a specific honeypot architecture and possible implementation variants conf. The evaluation unit 201 selects the configuration (and, if applicable, also the honeypot architecture) in such a way that the implemented honeypot 203 correctly replicates the selected target system and the honeypot itself is securely implemented and configured. The honeypot configuration device 200 then initiates the deployment, i.e. the implementation, of the honeypot (e.g. the honeypot 106 on the data processing device 105).

Thus, the evaluation unit 201 receives a written system specification of the target system. This specification can vary in nature, e.g. can be a standardized system specification, i.e., a system specification issued by a standardization body (e.g. an RFC (request for comments) document), a customer-specific specification or a vendor specification or include a plurality of these. Since the specification includes information about the system services, the operating system and other properties of the target system, the evaluation unit 201 is able to not only select a suitable honeypot architecture, but also to configure the honeypot, such as selecting a specific implementation variant.

The evaluation unit 201 can interpret the given system specification of the target system—regardless of its form—in different ways:

According to various embodiments, the evaluation unit 201 uses a machine learning model MAL, which receives (at least) the specification of the target system as an input and is trained to ascertain a honeypot configuration for a honeypot architecture (and, if applicable, also an indication of the honeypot architecture) from its input. For example, the machine learning model 204 is a large language model that can interpret the specification text and suggest a possible solution. Since honeypots are an issue of cybersecurity, such models must meet security requirements in order to automatically select and configure honeypots.

The ascertainment of the configuration (and, if applicable, honeypot architecture) can be supplemented by
Interpreting the specification of the target system by means of static rules which, for example, enable pattern recognition. If the system specification includes e.g. the keyword SSH including a version number, an analysis result may be that a honeypot is selected which implements the specific SSH version and configures the configuration to include the system-specific SSH banners (e.g., SSH-2.0-OpenSSH 7.4 QNX Secure Shell)
Forming Boolean expressions from the specification of the target system: These can be formed from a written specification such that they are easier for an algorithm (in particular a machine learning model) to interpret. A Boolean expression includes variables. Depending on their assignment (true or false), the expression as a whole is evaluated as true or false. A honeypot whose features evaluate the entire expression as true can then be selected. An expression for a honeypot with the services SSH and MQTT and a Linux OS or a configurable OS interface could look like this: (Service_SSH AND Service_MQTT) AND (OS Linux OR OS_Configurable). A request to the honeypot can thus be formed as a Boolean expression.
Additional heuristic or deterministic procedures can be selected in order to support the machine learning model in selecting and configuring a suitable honeypot.

This extension of the machine learning model MAL can be effected in such a way that the system specification of the target system is analyzed in one or more of the ways mentioned above (static rules, Boolean expressions, etc.) and the result of this analysis is used as a further input for the machine learning model. This additional input can be weighted against the rest of the input, so that the machine learning model follows this input more strictly or less strictly.

According to various embodiments, the machine learning model is specifically trained for the approach described above, also with a view to fulfilling security requirements. The machine learning model can be trained in a supervised manner using training examples, which in each case include a training input (i.e., training system specification and, if applicable, additional material, depending on what the machine learning model processes) and a target output (with at least one honeypot configuration matching the training system specification). Such training examples can also be partially generated automatically (e.g., by slight variations in the system specification and corresponding changes in the honeypot configuration).

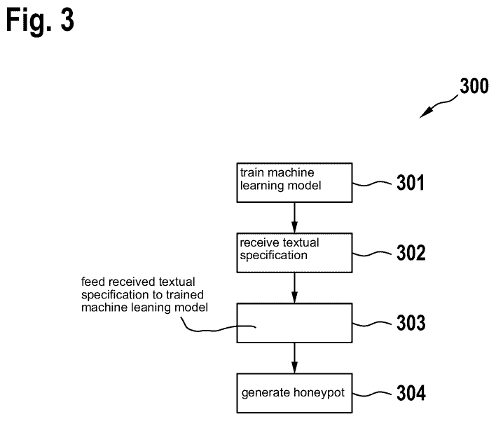

In summary, according to various embodiments, a method is provided as shown in FIG. 3.

FIG. 3 shows a flowchart 300 illustrating a method for generating a honeypot for a target system according to one embodiment.

In 301, a machine learning model is trained, in response to an input (i.e., an input on which the machine learning model is trained) that includes a textual target system specification, to output a honeypot configuration matching the input (i.e., for a textually specified target system to be imitated by a honeypot, to output an appropriate configuration for such a honeypot).

In 302, a textual specification of the target system is received.

In 303, the received textual specification is fed to the trained machine learning model.

In 304, a honeypot is generated according to the configuration which the machine learning model outputs in response to the feed of the received textual specification.

The method of FIG. 3 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

1-10. (canceled)

11. A method for generating a honeypot for a target system, comprising:
training a machine learning model to output, in response to an input that includes a textual target system specification, a honeypot configuration matching the input;
receiving the textual specification of the target system;
feeding the received textual specification to the trained machine learning model; and
generating a honeypot according to the configuration output by the machine learning model in response to the feeding of the received textual specification.

12. The method according to claim 11, further comprising:
prior to feeding the received textual specification to the trained machine learning model, removing data to be kept secret according to a confidentiality criterion from the textual specification.

13. The method according to claim 11, wherein the input on which the machine learning model is trained and the received textual specification in each case include an indication of services and/or protocols to be supported by the honeypot, and/or one or more operating systems to be supported by the honeypot.

14. The method according to claim 11, further comprising evaluating the generated honeypot and updating the machine learning model according to the evaluation.

15. The method according to claim 11, wherein the input on which the machine learning model is trained includes information in the form of a result of a static rule, and wherein the static rule is applied to the received textual specification, and the received textual specification is fed to the machine learning model together with a result of the application.

16. The method according to claim 11, wherein the input on which the machine learning model is trained includes at least one Boolean expression of target system functionalities and/or target system properties, and wherein at least one Boolean expression is ascertained from the received textual specification and is fed to the machine learning model with the received textual specification.

17. The method according to claim 11, wherein the machine learning model is a large language model.

18. A data processing system with a honeypot generating device which is configured to generate a honeypot for a target system, the honeypot generating device being configured to:
train a machine learning model to output, in response to an input that includes a textual target system specification, a honeypot configuration matching the input;
receive the textual specification of the target system;
feed the received textual specification to the trained machine learning model; and
generate a honeypot according to the configuration output by the machine learning model in response to the feeding of the received textual specification.

19. A non-transitory computer-readable medium on which are stored commands for generating a honeypot for a target system, the commands, when executed by a processor, causing the processor to perform the following steps:
training a machine learning model to output, in response to an input that includes a textual target system specification, a honeypot configuration matching the input;
receiving the textual specification of the target system;
feeding the received textual specification to the trained machine learning model; and
generating a honeypot according to the configuration output by the machine learning model in response to the feeding of the received textual specification.
